(19) United States
(12) Patent Application Publication
(10) Pub. No.: US 2007/0178263 A1
(43) Pub. Date: Aug. 2, 2007

(54) Binder with barrier properties

(76) Inventors: Annabelle Guilleux, Duesseldorf (DE); Sara Wagner, Mettmann (DE); Kamil Kalus, Duesseldorf (DE)

Correspondence Address: HENKEL CORPORATION, THE TRIAD, SUITE 200, 2200 RENAISSANCE BLVD., GULPH MILLS, PA, 19406, US

(21) Appl. No.: 11/702,463

(22) Filed: Feb. 5, 2007

Related U.S. Application Data
(63) Continuation of application No. PCT/EP05/06835, filed on Jun. 24, 2005.

(30) Foreign Application Priority Data
Aug. 6, 2004 (DE) 10 2004 038 274.3

(51) Int. Cl. B32B 27/32; B32B 27/40; B32B 1/08; B32B 27/00

(52) U.S. Cl. 428/35.2; 428/500; 428/423.1

(57) ABSTRACT

The invention provides a binder with barrier properties containing at least one compound containing at least one radiation-curable reactive functional group which is flowable at 18° C. to 100° C. and preferably at 20° C. to 80° C. as component (A), at least one compound containing at least one radiation-curable reactive functional group and at least one COOH group as component (B), and at least one nanoscale filler preferably selected from the group consisting of oxides, nitrides, halides, sulfides, carbides, tellurides, selenides of the second to fourth main group, the transition elements, the lanthanides and/or from the group of polyorganosiloxanes as component (C). The binder is used as a radiation-curing binder in coatings, fillers, sealers or adhesives, particularly in the production of laminate films with barrier properties such as those used in food packaging.

### CROSS-REFERENCE TO RELATED APPLICATIONS

This application is a continuation under 35 USC Sections 365(c) and 120 of International Application No. PCT/EP2005/006835 filed 24 Jun. 2005 and published 16 Feb. 2006 as WO 2006/015659, which claims priority from German Application No. 102004038274.3, filed 6 Aug. 2004, each of which is incorporated herein by reference in its entirety.

### FIELD OF THE INVENTION

This invention relates to binders with barrier properties, to their use for bonding, coating and sealing, to a process for the production of multi-layer materials using the binders with barrier properties according to the invention and to the use of these multi-layer materials for packaging.

### DISCUSSION OF THE RELATED ART

Many goods have to be protected from the ambient air or surrounding atmosphere for transportation or storage while other goods, particularly those with high water contents, have to be protected against drying out. Accordingly, they have to be packaged in a way which is suitable for completely excluding all or certain constituents of the surrounding atmosphere or for preventing the diffusion of water or flavors into the surrounding atmosphere and hence drying out of the packaged product or changes in its taste.

Whereas fuels and heating oils, for example, are transported and stored in suitable containers for this purpose, flexible packs are frequently used in the medical field (medicaments, ampoules) and in the staple and luxury food industry.

A particularly critical constituent of the ambient atmosphere is oxygen. With many packaged goods, such as foods or medicaments for example, the presence of oxygen can lead to oxidative deterioration or to the growth of germs which can also spoil the packaged product.

Polymer films of thermoplastic films are widely used for the production of flexible packs. These polymer films are normally produced by simple molding process, such as extrusion or blow molding.

Since the various requirements which a modern packaging film is expected to meet cannot all be satisfactorily fulfilled by a polymer film of a single polymer, a change was made some time ago to the production of so-called laminated films, i.e., films with a multilayer structure. In order to obtain the essential basic properties of a packaging film, such as tear strength, neutral taste and barrier properties, various processes are used to bond the individual film constituents together to form a laminated film.

For example, multilayer systems with separate barrier layers are produced by combining polyvinylidene chloride (PVDC), ethylene/vinyl alcohol (EVOH) and/or aluminium films/foils with polyethylene films, polyester films and/or polyvinyl chloride films. These multilayer systems can be made either by co-extrusion or by bonding separately produced films.

In another process, packaging films, for example based on polyethylene terephthalate or biaxially stretched polypropylene, are “metallized” (in vacuo) with an aluminum and/or silicon oxide layer.

Another known process uses the surface treatment of flexible packaging films by coating the films with solvent- or water-based polyvinylidene chloride solutions or dispersions.

PVDC- or EVOH-based coating compositions and adhesives often show poor adhesion to polyolefin films. Laminates of polyolefin films involving such adhesives can often be peeled apart by hand. Accordingly, a primer may have to be applied in a preliminary process step in order to ensure firm adhesion of the surface coating or the adhesive to the substrate film.

These known processes for the production of packaging/laminated materials with good barrier properties are generally very complicated and expensive. In practice, the use of metal layers by vapor deposition of metal or by lamination of metal foils results time and again in defects through a plurality of fine holes in the metal layer which seriously impair the otherwise good barrier effect of the metal layer.

In the search for more simple processes, there is a demand for adhesives which, besides the necessary adhesive effect, also act as a barrier against oxygen, flavors and water vapor.

EP 0906944 A2 relates to solventless polyurethane adhesives which have barrier properties against oxygen and moisture. These polyurethane adhesives are obtainable by reaction of a linear diol with a linear polyester to form a crystalline hydroxyl-terminated polyester which is reacted with a liquid diisocyanate in an NCO:OH ratio of ca. 1:1 to ca. 1.1:1. The polyurethane adhesives thus obtained are used as lamination adhesives. The disadvantage of coating compositions of this type is that they often lack the required flexibility. Another disadvantage is that long reaction times are necessary for obtaining good barrier properties.

WO 02/26908 describes lamination adhesive compositions based on polymeric binders and, more particularly, based on one- or two-component polyurethane adhesives which, in the binder matrix, contain fillers with a platelet-like crystallite structure having aspect ratios of >100. The fillers are dispersed, for example, into the hydroxyl-containing component of the two-component adhesive. The lamination adhesives show a considerable reduction in the oxygen transmission rate. However, the pot life can be too short for some applications.

The problem addressed by the present invention was to improve the processing and performance properties of binders with barrier properties. Another problem addressed by the present invention was to provide binders having barrier properties, more particularly against CO₂, O₂, N₂, water vapor and flavors, which could be applied at low temperatures, i.e., at 20° C. to 100° C., preferably at 25 to 80° C. and more particularly at 30° to 60° C. and which would show good early adhesion. The binders would be suitable in particular as lamination adhesives for the packaging of foods.

Where the binders are used as sealants or fillers, shrinkage during curing would be minimal. Where the binders are used, for example, for coating or as an adhesive, adhesion to surfaces that are hard to wet would be improved.

Another problem addressed by the present invention was to provide adhesives, sealants and fillers which would lend themselves to rapid further processing.

### BRIEF SUMMARY OF THE INVENTION

The invention provides a binder with barrier properties containing
A) at least one compound containing at least one radiation-curable reactive functional group which is flowable at 18° C. to 100° C. and preferably at 20° C. to 80° C. as component (A);
B) at least one compound containing at least one radiation-curable reactive functional group and at least one COOH group as component (B); and
C) at least one nanoscale filler preferably selected from the group consisting of oxides, nitrides, halides, sulfides, carbides, tellurides, selenides of the second to fourth main group, the transition elements, the lanthanides and/or from the group of polyorganosiloxanes as component (C).

### DETAILED DESCRIPTION OF CERTAIN EMBODIMENTS OF THE INVENTION

The binder according to the invention has barrier properties against CO₂, O₂, N₂, water vapor and flavors. Its preferred use as a sealant or adhesive reduces the number of process steps involved in the production of multi-layer materials with barrier properties because there is no longer any need for additional coatings with polyvinylidene chloride and/or ethylene/vinyl alcohol layers or for metallizing with aluminum layers. Through the absence of a metal layer, the multi-layer materials comprise purely plastic films and hence are easier to dispose of. In particular, the absence of a metal layer allows the production of transparent film laminates with barrier properties.

The binders according to the invention have a viscosity at 60° C. of 50 mPa·s to 52,000 mPa·s (as measured with a Brookfield RVT DV-II digital viscosimeter, spindle 27) and, accordingly, may readily be applied at low temperatures, i.e., at temperatures of 40° C. to 120° C. In particular, they rapidly develop good early adhesion. Temperature-sensitive substrates, for example polyolefin films, can thus be securely bonded without any damage to the substrate.

The adhesive composition according to the invention is radiation-curable and, in a preferred embodiment, is used as a dual-cure system. In this case, the binders should be water-free. Dual-cure systems are distinguished by the fact that they are both radiation-curable and can be cured by a second, independent curing mechanism. The binders according to the invention may preferably be used as one-component (1C) systems, so that there is no need for any additional components, particularly hardeners.

The adhesives, sealants and fillers containing the binder according to the invention contain few, if any, migratable constituents. There is thus no need for the otherwise usual wait for complete curing after application of the adhesive, sealant or filler.

Binders in the context of the present invention are understood to be materials which bind substrates of the same kind or of different kinds or which can themselves adhere firmly to such substrates.

The terms “hardening, “curing” or similar terms in the present specification relate to polyreactions which can take place within individual components of the particular composition considered in connection with the term. The polyreaction may be a radical, anionic or cationic polymerization, polycondensation or polyaddition reaction in which one reactive functional group is able to react with another, suitable functional group with an increase in the molecular weight of the molecule carrying that group. Normally, crosslinking reactions also take place at the same time.

In the context of the present invention, the “radiation-curable” feature is understood to be the initiation of a polyreaction under the effect of radiation. The radiation can be any form of radiation which produces irreversible crosslinking in the crosslinkable binder layer to be irradiated. Suitable forms of radiation include in particular UV radiation, electron beams, visible light and IR radiation. An example of a reactive functional group curable by radiation is a group containing a carbon-carbon double bond.

Molecular weights mentioned in relation to polymeric compounds represent the number average molecular weight (Mₙ), unless otherwise stated. All molecular weights mentioned are values obtainable by gel permeation chromatography (GPC), unless otherwise indicated.

Monomeric, oligomeric and polymeric compounds are suitable for use as component (A) providing they contain at least one radiation-curable reactive functional group. Component (A) is preferably flowable at 18° C. to 100° C. and preferably at 20° C. to 80° C. Such compounds suitable for use as component (A) are selected from the group consisting of poly(meth)acrylic acid alkyl, cycloalkyl or aryl esters, (meth)acrylic acid homo- and/or copolymers, unsaturated polyesters, polyethers, polycarbonates, polyacetals, polyurethanes, polyolefins, vinyl polymers or rubber polymers, such as nitrile or styrene/butadiene rubber. Compounds suitable as component (A) for the purposes of the invention are described, for example, by C. G. Roffey in “Photogeneration of Reactive Species for UV Curing”, John Wiley & Sons, 1997, on pages 182 (vinyl derivatives), 482-485 (unsaturated polyesters), 487-502 (polyester, polyether, epoxy, polyurethane and melamine acrylates), 504-508 (radiation-crosslinkable organosiloxane polymers) and by R. Holman and P. Oldring in “U.V. and E.B. Curing Formulation for Printing Inks, Coatings and Paints”, SIFA (Selective Industrial Training Associates Limited, London, U.K.), 2nd Edition, 1988, on pages 23-26 (epoxy acrylates), 27-35 (urethane acrylates), 36-39 (polyester acrylates), 39-41 (polyether acrylates), 41 (vinyl polymers), 42-43 (unsaturated polyesters).

Compounds from the group consisting of (meth)acrylic acid homo- and/or copolymers, polyester(meth)acrylates, epoxy(meth)acrylates or polyurethane(meth)acrylates are preferably used as component (A). The term “(meth)acrylate” is meant to be a shortened form of “acrylate and/or methacrylate”.

Comonomers of (meth)acrylic acid which contain styrene, methyl styrene and/or other alkyl styrenes and α-olefins as comonomer are preferred.

Acrylate or methacrylate esters with a functionality of two and/or more are particularly suitable as component (A). Such acrylate or methacrylate esters preferably include esters of acrylic acid or methacrylic acid with aromatic, aliphatic or cycloaliphatic polyols or acrylate esters of polyether alcohols. Suitable compounds are described by C. G. Roffey in “Photogeneration of Reactive Species for UV Curing” on pages 537-560 and by R. Holman and P. Oldring in “U.V. and E.B. Curing Formulation for Printing Inks, Coatings and Paints” on pages 52-59.

Compounds particularly preferred as component (A) include (meth)acrylate esters of aliphatic polyols containing 2 to about 40 carbon atoms. Compounds such as these are preferably selected from the group consisting of neopentylglycol di(meth)acrylate, 1,6-hexanediol di(meth)acrylate, trimethylolpropane tri(meth)acrylate, pentaerythritol tetra(meth)acrylate and (meth)acrylate esters of sorbitol and other sugar alcohols. These (meth)acrylate esters of aliphatic or cycloaliphatic diols may be modified with an aliphatic ester or an alkylene oxide. Acrylates modified by an aliphatic ester include, for example, neopentylglycol hydroxypivalate di(meth)acrylate, caprolactone-modified neopentylglycol hydroxypivalate di(meth)acrylates and the like. Alkylene oxide-modified acrylate compounds include, for example, ethylene oxide-modified neopentylglycol di(meth)acrylates, propylene oxide-modified neopentylglycol di(meth)acrylates, ethylene oxide-modified 1,6-hexanediol di(meth)acrylates or propylene oxide-modified 1,6-hexanediol di(meth)acrylates or mixtures of two or more thereof.

Acrylates or methacrylates containing aromatic groups may also be used. These include corresponding bisphenol A compounds, for example diacrylates or dimethacrylates of adducts of bisphenol A with alkylene oxides, for example adducts of bisphenol A with ethylene oxide and/or propylene oxide. Acrylate monomers based on polyether polyols include, for example, neopentylglycol-modified (meth)acrylates, trimethylolpropane di(meth)-acrylates, polyethylene glycol di(meth)acrylates, polypropylene glycol di(meth)acrylates and the like. Acrylate monomers with a functionality of three or more include, for example, trimethylolpropane tri(meth)acrylate, penta-erythritol tri- and tetra(meth)acrylate, dipentaerythritol tetra(meth)acrylate, dipentaerythritol penta(meth)acrylate, dipentaerythritol hexa(meth)acrylate, caprolactone-modified dipentaerythritol hexa(meth)acrylate, pentaerythritol tetra(meth)acrylate, tris[(meth)acryloxyethyl]isocyanurate, caprolactone-modified tris[(meth)acryloxyethyl]isocyanurate or trimethylolpropane tetra(meth)acrylate or mixtures of two or more thereof.

Of the above-mentioned acrylate monomers with a functionality of two, three or more which may be used as component (A) in accordance with the invention, di-, tri- and tetrapropylene glycol diacrylate, neopentyl glycol propoxylate di(meth)acrylate, trimethylolpropane tri(meth)acrylate, trimethylolpropane monoethoxy tri(meth)acrylate and pentaerythritol triacrylate are preferred.

(Meth)acrylate esters based on polyols containing urethane groups may be produced by reacting a polyol with a difunctional or higher isocyanate to form OH-terminated polyurethane prepolymers which are esterified with (meth)acrylic acid to form the corresponding diesters.

In a particularly preferred embodiment, compounds corresponding to general formula (I):
H₂C═CR¹—C(═O)—O—(R⁷—O)ₙR⁸ (1)
where
R¹=H, CH₃;
R⁷=linear or branched C₂-C₁₀ alkylene group;
R⁸=linear or branched C₁-C₂₅ alkyl group;
n=1 to 25
are used as component (A).

Preferred compounds corresponding to general formula (I) are methoxyethyl acrylate, ethoxymethyl methacrylate, methoxyethoxyethyl methacrylate, ethoxyethoxyethyl acrylate, butyl diethylene glycol methacrylate, ethoxylated nonylphenol acrylate, ethoxylated lauryl alcohol methacrylate, alkoxylated tetrahydrofurfuryl acrylate, methoxy polyethylene glycol monoacrylate.

In a particularly preferred embodiment, component (A) is selected from the group consisting of hydroxyfunctional ethylhexyl methacrylate, octyl-/decyl acrylate, ethoxylated trimethylolpropane triacrylate, modified aromatic or aliphatic epoxyacrylates, neopentyl glycol di(meth)acrylate, 1,6-hexanediol di(meth)acrylate, trimethylolpropane tri(meth)acrylate, pentaerythritol tetra(meth)acrylate, neopentylglycol hydroxypivalate di(meth)acrylate, caprolactone-modified neopentylglycol hydroxypivalate di(meth)acrylates, ethylene-oxide-modified neopentylglycol di(meth)acrylates, propylene-oxide-modified neopentylglycol di(meth)acrylates, ethylene-oxide-modified 1,6-hexanediol di(meth)acrylates, propylene-oxide-modified 1,6-hexanediol di(meth)acrylates, polyethylene glycol di(meth)acrylates, polypropylene glycol di(meth)acrylates, pentaerythritol tri(meth)acrylate, dipentaerythritol tetra(meth)acrylate, dipentaerythritol penta(meth)acrylate, dipentaerythritol hexa(meth)acrylate, caprolactone-modified dipentaerythritol hexa(meth)acrylate, tris[(meth)acryloxyethyl]-isocyanurate, caprolactone-modified tris[(meth)acryloxyethyl]-isocyanurate, di-, tri- and tetrapropylene glycol diacrylate, neopentyl glycol propoxylate di(meth)acrylate, trimethylolpropane monoethoxy tri(meth)acrylate, amine-modified polyether acrylates.

The molecular weight of compound (A) is in the range from 100 to 15,000 g/mol, preferably in the range from 100 to 10,000 g/mol and more particularly in the range from 100 to 8,000 g/mol.

Compound (A) makes up from 5 to 60% by weight, preferably from 5 to 45% by weight and more particularly from 5 to 30% by weight of the radiation-curable binder with barrier properties according to the invention.

Acylated carboxylic-acid-terminated polyesters, carboxylic-acid-modified polybutadienes and polyetherpolyol-based acid-modified (meth)acrylates are preferably used as component (B). The last of these are obtainable by reaction of polyether polyols, such as ethylene glycol or propylene glycol, with aromatic or aliphatic dicarboxylic acids, such as adipic acid or phthalic acid, and (meth)acrylic acid.

Component (B) is selected in particular from the products disclosed in U.S. Pat. No. 6,429,235, incorporated herein by reference in its entirety.

Preferred commercially available compounds used as component (B) are obtainable from Cognis under the name of PHOTOMER® 5429F, 5432, 4173, 4149, 3038 or 4017, from BASF under the name of LAROMER PE 44F, PE 55F, PE 56F, 8800, 8981, or 9004, from Cray Valley under the name of CRAYNOR 203, 293, 294E, UVP 210, or UVP 220 or under the name of SYNOCURE AC 1007, from Rahn under the name of GENOMER 6043, or 6050, from UCB under the name of EBECRYL 436, 438, 584, 586, or 588.

The molecular weight of compound (B) is in the range from 100 to 15,000 g/mol, preferably in the range from 100 to 10,000 g/mol and more particularly in the range from 100 to 8,000 g/mol.

Compound (B) makes up from 5 to 70% by weight, preferably from 10 to 60% by weight and more particularly from 20 to 40% by weight of the radiation-curable binder with barrier properties according to the invention.

The binder according to the invention contains as component (C) a nanoscale filler preferably selected from the group consisting of oxides, nitrides, halides, sulfides, carbides, tellurides, selenides of the second to fourth main group, the transition elements, the lanthanides and/or from the group of polyorganosiloxanes. Nanoscale fillers are also known as nanodisperse fillers or “nanoparticles” because the smallest particle forming a rigid unit in the dispersion in the number-weighted average of all particles has a dimension of no more than 1,000 nanometers (nm), preferably no more than 500 nm and, more particularly, no more than 100 nm in at least one direction selectable as required for each particle. For example, the nanoparticles have a spherical, rodlet-like or platelet-like structure or are mixtures of various structures. The nanoparticles present in the nanoscale filler preferably have sizes of 1 to 40 nm and more particularly 3 to 30 nm as a number-weighted average. The particle size is preferably determined by the UPA method (Ultrafine Particle Analyzer), for example by laser light back scattering in order to prevent or avoid agglomeration or coalescence of the nanoparticles, the nanoparticles may be surface-modified or surface-coated in known manner. One process for the production of agglomerate-free nanoparticles is described in DE-A-19614136, columns 8 to 10, with reference to the example of iron oxide particles. Some possible methods for the surface-coating of such nanoparticles to avoid agglomeration are described in DE-A-19726282.

A preferred embodiment of the invention is characterized by the use of nanoscale fillers of which the smallest constituents forming a rigid unit in the dispersion each have a dimension in two directions perpendicular to one another, selectable as required, of at least ten times the size of the constituents in the direction with the smallest dimension of the constituent. The thickness of these particles is preferably smaller than 10 nm.

The nanoscale filler is selected from the group consisting of oxides, nitrides, halides, sulfides, carbides, tellurides, selenides of the second to fourth main group, the transition elements or the lanthanides, more particularly oxides, hydroxides, nitrides, halides, carbides or mixed oxide/hydroxide/halite compounds of aluminium, silicon, zirconium, titanium, tin, zinc, iron or the alkali (alkaline earth) metals. These materials are essentially aluminas, for example aluminium oxides, boehmite, bayerite, gibbsite, diaspore and the like. Layer silicates such as, for example, bentonite, montmorillonite, hydrotalcite, hectorite, kaolinite, boehmite, mica, vermiculite or mixtures thereof are suitable. Phyllosilicates, such as magnesium silicate or aluminium silicate, and montmorillonite, saponite, beidellite, nontronite, hectorite, stevensite, vermiculite, halloysite or synthetic analogs thereof are particularly preferred. Of the cristobalite, quartz and tridynite modifications of silicon dioxide, the quartz modification is preferred.

Other suitable nanoscale fillers are magnesium oxide, aluminium oxide, magnesium fluoride, cadmium sulfide, zinc sulfide, cadmium selenide and the like.

In a particularly preferred embodiment of the invention, component (C) is amorphous silicon dioxide.

The SANS technique (small angle neutron scattering) is used to measure the nanoparticles, more particularly the amorphous silicon dioxide particles. This technique is familiar to the expert and does not require a detailed explanation here. In the SANS technique, a particle size distribution curve is obtained in which the percentage by volume of particles of appropriate size (diameter) is plotted against the particle diameter. In the context of the invention, the mean particle size is defined as the peak of a SANS distribution curve, i.e., the largest fraction by volume with particles of corresponding diameter. The mean particle size is preferably between 6 and 40 nm, more preferably between 8 and 30 nm and most preferably between 10 and 25 nm. The silicon dioxide particles are preferably substantially spherical.

The nanoscale filler used as component (C) makes up from 5% by weight to 50% by weight, preferably from 20% by weight to 45% by weight and more particularly from 30% by weight to 40% by weight of the binder according to the invention.

In a particularly preferred embodiment, the nanoscale filler is dispersed in a flowable phase, the flowable phase containing polymerizable monomers, oligomers and/or polymers. The flowable phase may consist of a mixture of components (A), (B) and (D). In a preferred embodiment, the flowable phase is formed from component (A). In a particularly preferred embodiment, the flowable phase used as the dispersion medium is water-free, i.e., it contains only small traces of water.

Processes for the production of such dispersions and silicon dioxide dispersions themselves are disclosed in EP-A1-1236765, of which the entire disclosure is included in the disclosure of the present application.

Commercially available dispersions of components (A) and (C) are obtainable from Hanse Chemie under the name of Nanocryl®. Preferred products are Nanocryl® XP 21/0746, XP 21/0768, XP 21/0396, XP 21/1045 and XP 21/1515.

In another preferred embodiment, the binder according to the invention contains at least one organosilicon compound as compound (D). From the group of organosilicon compounds suitable for use as component (D), at least one three-dimensionally crosslinkable polyorganosiloxane, which has a mean particle diameter of 70 nm to 1,000 nm after crosslinking, is used as component (D1). Corresponding polyorganosiloxanes are described in EP-B1-0407834, page 3, line 43 to page 4, line 19.

In a preferred embodiment, component (D) as component (D2) is a reaction product, preferably an esterification or transesterification product, of acrylic acid and/or methacrylic acid or derivatives thereof with a silane (e) corresponding to general formula (II):
Y-A-Si((Z)ₙ)(T)₃₋ₙ (II)
in which
Y=epoxide, —OH, —COOH, —SH, —NH₂, NHR″ group;
R″=linear or branched, saturated or unsaturated C₁₋₁₈ alkyl, C₅₋₈ cycloalkyl, C₆₋₁₀ aryl, C₇₋₁₂ aralkyl group; oxyalkylene group containing up to 4 carbon atoms, preferably —(CH₂—CH₂—O)ₘ—H and/or (CH₂—CH(CH₃)—O—)ₘ—H; A-Si((Z)ₙ(T)₃₋ₙ; an alkyl-, cycloalkyl- or aryl-substituted siloxane group containing about 1 to about 20 Si atoms;
A=linear or branched, saturated or unsaturated alkylene group containing 1 to 12 carbon atoms, preferably a linear or branched alkylene group containing 1 to 4 carbon atoms;
Z=C₁₋₁₈ alkyl group, preferably C₁₋₄ alkyl group;
T=—NH₂, —NH—CO—R⁵, —OOC—R⁵, —O—N═C(R⁵)₂ or OR⁶;
R⁵=linear or branched, saturated or unsaturated C₁₋₁₈ alkyl group, preferably a methyl, ethyl, propyl or isopropyl group;
R⁶=R⁵, preferably a methyl, ethyl, propyl or isopropyl group; or an oxyalkylene group containing up to 4 carbon atoms, preferably —(CH₂—CH₂—O)ₘ—H and/or (CH₂—CH(CH₃)—O)ₘ—H; a C₅₋₈ cycloalkylene group; a C₆₋₁₀ aryl group or a C₇₋₁₂ aralkyl group;
m=1 to 40, preferably 1 to 20 and more particularly 1 to 10;
n=0, 1 or 2.

The following are examples of compounds corresponding to formula (II): H₂N—CH₂—Si(O—CH₂—CH₃)₃, HO—CH₂—Si(OCH₃)₃, HO—(CH₂)₃—O—CH₂—Si(O—CH₃)₃, HO—CH₂—CH₂—O—CH₂—Si(OCH₃)₃, (HO—C₂H₄)₂N—CH₂—Si(O—CH₃)₃, HO—(C₂H₄—O)₃—C₂H₄—N(CH₃)—CH₂—Si(O—CH₃)₃, H₂N—CH₂—C₆H₄—CH₂—NH—CH₂—Si(O—CH₃)₃, HS—CH₂—Si(O—CH₃)₃, H₂N—(CH₂)₃—NH—CH₂—Si(OCH₃)₃, H₂N—CH₂—CH₂—NH—CH₂—Si(O—CH₃)₃, HN—((CH₂)₃—Si(O—CH₂—CH₃)₃)₂, or CH₃—(CH₂)₃—NH—(CH₂)₃—Si(O—CH₃)₃, H₂N—(CH₂)₃—Si(O—C₂H₅)₃, H₂N—CH(CH₃)—CH₂—Si(O—CH₃)₃, H₂N—(CH₂)₃—Si(O—CH₃)₃, H₂N—CH₂—CH₂—O—CH₂—CH₂—Si(O—CH₃)₃, (HO—C₂H₄)₂N—(CH₂)₃—Si(O—CH₃)₃, HO—(C₂H₄—O)₃—C₂H₄—N(CH₃)—(CH₂)₃—Si(O—C₄H₉)₃, H₂N—CH₂—C₆H₄—CH₂—CH₂—Si(O—CH₃)₃, H₂N—(CH₂)₃—NH—(CH₂)₃—Si(O—CH₃)₃, H₂N—CH₂—CH₂—NH—(CH₂)₂—Si(OCH₃)₃, H₂N—(CH₂)₂—NH—(CH₂)₃—Si(O—CH₃)₃, H₂N—CH(C₂H₅)—CH₂—Si(O—CH₃)₃, H₂N—CH₂—CH₂—O—CH₂—CH₂—Si(O—C₂H₅)₃, (HO—C₂H₄)₂N—(CH₂)₃—Si(O—C₂H₅)₃, H₂N—CH₂—C₂H₄—CH₂—CH₂—Si(O—C₂H₅)₃, H₂N—(CH₂)₃—NH—(CH₂)₃—Si(O—C₂H₅)₃, H₂N—CH₂—CH₂—NH—(CH₂)₂—Si(O—C₂H₅)₃, H₂N—(CH₂)₂—NH—(CH₂)₃—Si(O—C₂H₅)₃ and mixtures of two or more thereof.

According to the invention, 3-aminopropyl trimethoxysilane, 3-aminopropyl dimethoxysilane, 3-aminopropyl triethoxysilane, 3-aminopropyl dimethoxyphenyl silane and 3-aminopropyl diethoxysilane, more particularly 3-aminopropyl trimethoxysilane or bis-(3-triethoxysilylpropyl)-amine, or mixtures thereof is/are used as the silane(s) corresponding to general formula (II).

Commercially available silanes (e) are obtainable from Dynamit Nobel under the name of DYNASYLAN®. These are alkoxysilane derivatives containing two or three alkoxy groups and one or two alkyl groups to which functional groups, for example amino, mercapto, methacryloxy or a nitrile group or a halogen atom, such as chlorine, may be also be attached.

In a particularly preferred embodiment, 3-methacryloxypropyl trimethoxysilane and/or allyl triethoxysilane is used as component (D2). Component (D2) may be used on its own or in the form of a mixture with component (D1).

In another preferred embodiment, component (D) as component (D3) is a silane containing urethane groups with an isocyanate content of <1% by weight, preferably <0.5% by weight and more particularly <0.1% by weight NCO. Component (D3) may be used on its own or in the form of a mixture with component (D1) and/or component (D2). Silanes containing urethane groups such as these are obtainable by reaction of polyisocyanates (c) with silanes (e) corresponding to general formula (II).

Component (D1), (D2) and/or (D3) is/are present in quantities of 0.3% by weight to 20% by weight, preferably in quantities of 0.4% by weight to 15% by weight and more particularly in quantities of up to 0.5% by weight.

In a particularly preferred embodiment, from the group of organosilicon compounds suitable for use as component (D), silanes containing urethane groups with at least one radiation-curable reactive group are used as component (D4).

Component (D4) is produced by reacting at least one polyisocyanate (c) with at least one compound (d) containing both at least one NCO-reactive functional group and at least one radiation-curable reactive functional group and with at least one silane (e) corresponding to formula (II). Corresponding processes are known to the expert.

According to the invention, non-symmetrical diisocyanates and/or polyurethane prepolymers containing free NCO groups are preferably selected from the group of polyisocyanates (c).

Non-symmetrical diisocyanates contain isocyanate groups differing in their reactivity in the molecule. Preferred non-symmetrical diisocyanates are 2,4-diphenylmethane diisocyanate (MDI), the isomers of toluene diisocyanate (TDI), 1-isocyanatomethyl-3-isocyanato-1,5,5-trimethyl cyclohexane (IPDI).

Information on the broad range of suitable polyol and isocyanate components and processes for the production of polyurethane prepolymers can be found in the literature on polyurethane prepolymers, cf. for example EP 0 150 444, EP 0 590 398 or WO 99/24486.

A low-monomer polyurethane prepolymer is preferably used as component (c), “low-monomer” in the context of the present invention being understood to be a low concentration of the monomeric, more particularly aromatic, diisocyanates in the PU prepolymer containing free NCO groups. The concentration of these so-called “residual monomers” is below 1% by weight, preferably between 0 and 0.5% by weight and more particularly between 0 and 0.2% by weight, based on the composition of the PU prepolymer containing free NCO groups. Low-monomer PU prepolymers containing free NCO groups are known, for example, from DE 4136490, WO 01/40342 and WO 97/46603 and are expressly included in the present invention.

The NCO-reactive functional group is a group containing an active hydrogen atom attached to an N, O or S atom which can be determined by the Zerewittinoff test. Such hydrogen atoms include in particular the hydrogen atoms of water, carboxy, amino, imino, hydroxy and thiol groups.

A methacrylate corresponding to general formula (III):
H₂C═CR¹—C(═O)—O—R²—Y (III)
in which
Y=an NCO-reactive group, preferably OH, COOH, SH, NH₂, NHR³;
R¹=H, CH₃;
R²=saturated or unsaturated, linear or branched alkylene group containing 2 to 21 carbon atoms, optionally substituted by functional groups, for example by a phenoxy or acetoxy group, preferably containing 2 to 6 carbon atoms, more particularly an ethylene, propylene, isopropylene, n-butylene, isobutylene group or a C₂₋₄ alkylene oxide group, preferably an ethylene oxide and/or propylene oxide group and, more particularly, an ethylene oxide group containing 2 to 10 ethylene oxide units and/or a propylene oxide group containing 1 to 7 propylene oxide units;
R³ is a linear or branched, saturated or unsaturated C₁₋₁₈ alkyl group; C₅₋₈ cycloalkyl, C₆₋₁₀ aryl, C₇₋₁₂ aralkyl,
   is preferably used as the compound (d) containing both at least one NCO-reactive functional group and at least one radiation-curable reactive functional group.

The production of (meth)acrylates corresponding to formula (III) is known to the expert.

Preferred (meth)acrylates corresponding to general formula (III) are hydroxy(meth)acrylates (Y═OH), for example 2-hydroxyethyl acrylate, 2-hydroxyethyl methacrylate, 2-hydroxypropyl acrylate, 2-hydroxypropyl methacrylate, 3-hydroxypropyl acrylate, 3-hydroxypropyl methacrylate, 6-hydroxyhexyl acrylate, 6-hydroxyhexyl methacrylate, polyethylene glycol acrylate, polyethylene glycol methacrylate, polypropylene glycol acrylate and polypropylene glycol methacrylate, glycerol mono(meth)acrylate, 1,3-glycerol di(meth)acrylate, 3-phenoxy-2-hydroxypropyl(meth)acrylate, 3-toluyloxy-2-hydroxypropyl(meth)acrylate, 3-acetoxy-2-hydroxypropyl(meth)acrylate, 2-hydroxy-3-[(2-methyl-1-oxo-2-propenyl)-hydroxy]-propyl ester of 4-hydroxybenzoic acid, 2-hydroxybutyl(meth)acrylate, 3-hydroxybutyl(meth)acrylate, 4-hydroxybutyl(meth)acrylate, 6-hydroxyhexyl(meth)acrylate. The hydroxy acrylates or methacrylates are used individually or in admixture.

The quantities of polyisocyanate (c) and (meth)acrylate corresponding to general formula (III) may be selected in a broad range. Thus, the ratio of NCO group of the polyisocyanate (c) to NCO-reactive group Y of the (meth)acrylate corresponding to general formula (III) may be between 0.6:1 to 20:1. The NCO:Y ratio is preferably 1.2:1 to 10:1.

The molecular weight of the reaction product of polyisocyanate (c) with compound (d), which contains both at least one NCO-reactive functional group and at least one radiation-curable reactive functional group, is in the range from 100 g/mol to 10,000 g/mol, preferably in the range from 110 g/mol to 6,000 g/mol and more particularly in the range from 120 g/mol to 4,000 g/mol. The NCO content of the reaction product of polyisocyanate (c) with compound (d), which contains both at least one NCO-reactive functional group and at least one radiation-curable reactive functional group, is between 2% by weight and 30% by weight and preferably between 5% by weight and 25% by weight (as determined by Spiegelberger's method).

Both mixtures of polyisocyanates (c) and/or mixtures of the silane (e) may be used for the production of component (D4). The reaction of the polyisocyanate component (c) with the silane (e) is carried out with a molar NCO:Y ratio of 1:0.01 to 1, preferably 1:0.05 to 0.7 and more particularly 1:0.1 to 0.4. The reaction product of the polyisocyanate component (c) and the silane (e) has an NCO content of 1-30%, preferably 10-28% and more particularly 15-25%, as determined by Spiegelberger's method, and a molecular weight of 100 g/mol to 1,000 g/mol. Processes for the production of such reaction products and the reaction products themselves are disclosed in DE-A1 10162642.

To produce component (D4), the at least one polyisocyanate (c), the at least one compound (d), which contains both at least one NCO-reactive functional group and at least one radiation-curable reactive functional group, and the at least one silane (e) are reacted with one another in a so-called “one-pot” reaction. However, the reaction may also be carried out in stages, i.e., in a first stage, (c) is reacted with (d) or (e) and, in a second stage, (e) or (d) is further reacted with the corresponding reaction product from the first stage.

At the end of the reaction, component (D4) has a content of free monomeric polyisocyanate of <0.05% by weight, based on the total weight of component (D4).

In order to mix component D with the binder according to the invention in a stable manner, component D should not contain any groups reactive to the other constituents under storage conditions. In particular, it should be free from isocyanate groups.

The functional group —Si(T)₃₋ₙ (II) of the organosilicon compound used as component (D3) and (D4) serves to build up an inorganic network of Si—O—Si units.

Where the binder according to the invention is used as a one-component (1C) adhesive, components (D3) and (D4) are preferably sensitive to hydrolysis, i.e., in the presence of water or atmospheric moisture, the Si-T bond is decomposed in a process accompanied by the release of corresponding cleavage products and crosslinking. Corresponding to the group T in formula (II), amines, acid amides, oximes or alcohols, for example, are formed as cleavage products during the crosslinking reaction (polycondensation reaction).

Formation of the Si—O—Si network can be monitored, for example, by Karl-Fischer titration (determination of water consumption during hydrolysis).

Component (C) is preferably capable of network formation, formation of the Si—O—Si network by polycondensation being particularly preferred.

In a preferred embodiment of the invention, a reaction can take place at the surface of component (C) with component (D) in the presence of a metal compound corresponding to formula (IV):
MR⁹ₓ (IV)
as component (E).

The metal M of this compound is selected from those elements of the main and subsidiary groups of the periodic system which, formally, can exist in oxidation stage 3 or 4. In a preferred embodiment, the metal M is Ge, Sn, Pb, Ti, Zr, B or Al. Depending on the valency, x is preferably 3 or 4. The substituent R⁹, which may be the same or different, is selected from halogen, alkoxy, alkoxycarbonyl and hydroxyl. However, since many compounds with the formal oxidation stage 3 or 4 can also exist as complexes with a plurality of ligands, the binder may instead or additionally contain compounds in which the groups R⁹ in formula (IV) are completely partly replaced by one or more ligands L which is/are bound to the metal M more strongly than the group R⁹. Compounds of this type are described, for example, in DE 10044216 A1 (see page 4, lines 1 to 31).

Suitable metal compounds are also known as “coupling agents” and represent one or more metal centers, such as Si, Ti, Zr or Al, which are attached to functional organic groups. Corresponding titanium, zirconium or aluminum compounds are described, for example, in DE 41128743 C2, pages 7 and 8. For the Zr and Ti compounds, r=0.

Component (E) is preferably selected from tetrabutyl titanate, tin(II) octanoate, dibutyl tin dilaurate, tetracetoxysilane or methyl trimethoxysilane. Other metal compounds preferably usable as component (E) are described in EP 1342742 A1, page 5, lines 28 to 52, and are included in the present invention.

Titanates are commercially obtainable as “KR” or “LICA” substances from Kenrich Petrochemicals, Inc. Similarly to the silanes mentioned above, these reagents are compounds containing alkoxy groups and optionally groups substituted by functional groups which are attached to the metal center via oxygen. The functional groups are, for example, amino, mercapto or hydroxyl groups.

Suitable zirconate compounds are, for example, the compounds optionally containing amino or mercapto groups obtainable as “KZ” or “LZ” reagents from Kenrich Petrochemicals, Inc.

Component (E) is used in the binder according to the invention in quantities of 0 to 12% by weight, preferably in quantities of 0.5 to 10% by weight and more particularly in quantities of 1 to 5% by weight, based on the total quantity of the components used. The reaction takes place in particular in the presence of water, i.e., above all after application as an adhesive, moisture is able to penetrate into the adhesive and to promote chemical crosslinking between components C and D and optionally E.

The polyreaction of the radiation-curable groups can be carried out with UV radiation, electron beams, visible light and also IR radiation. In the case of electron beams or UV radiation, the desired product properties are adjusted through the radiation dose, in the case of IR radiation through the product temperature and the residence time. The progress of the photochemical curing reaction can be followed by IR spectroscopy (intensity and relation of the C═C and C═O bands). Irradiation with UV light or electron beams is preferred for the purposes of the invention.

If the radiation-curable binder with barrier properties according to the invention is to be polymerized in UV light, at least one photoinitiator (F) is present in the binder composition. A photoinitiator (F) capable of initiating the radical polymerization of olefinically unsaturated double bonds on exposure to light with a wavelength of about 215 to about 480 nm is preferably used. In principle, any commercially available photoinitiators which are compatible with the binder according to the invention, i.e., which form at least substantially homogeneous mixtures, may be used as the photoinitiator (F) for the purposes of the present invention. Commercially available photoinitiators such as these are, for example, any Norrish-type I fragmenting substances, for example benzophenone, camphor quinone, QUANTACURE (a product of International Bio-Synthetics), KAYACURE MBP (a product of Nippon Kayaku), ESACURE BO (a product of Fratelli Lamberti), TRIGONAL 14 (a product of Akzo), photoinitiators of the Irgacure®, Darocure® or Speedcure® series (products of Ciba), for example Darocure® 1173 and/or Fi-4 (made by the Eastman Company). Of these, Irgacure® 651, Irgacure® 369, Irgacure® 184, Irgacure® 907, Irgacure® 907, Irgacure® 784, Irgacure® 500, Irgacure® 1000, Darocure® MBF, Irgacure® 1300, Darocur 4265, Darocur TPO, Irgacure 819 and 918 DW, Irgacure 2022 and Irgacure® 2959 or mixtures of two or more thereof are particularly suitable. Also suitable are phosphine oxide compounds (LUCIRIN TPO, a product of BASF AG) which may also be used in admixture with one or more of the photoinitiators mentioned above.

The binder with barrier properties according to the invention contains the photoinitiator (F) in a quantity of 0 to 15% by weight, preferably 0.5 to 10% by weight and more particularly 1 to 5% by weight, based on the binder composition as a whole.

The binder according to the invention may optionally contain additives (G) which may make up as much as about 50% by weight of the adhesive as a whole. The additives (G) suitable for use in accordance with the invention include, for example, plasticizers, catalysts, stabilizers, dispersants, antioxidants, dyes, fillers and agents for influencing the fluidity of the dispersion of component (C) in component (A), (B) or (D) or in a mixture of these components.

The binder with barrier properties according to the invention preferably contains
I. 5 to 80% by weight, preferably up to 60% by weight, more preferably up to 45% by weight and most preferably 5 to 30% by weight of at least one compound containing at least one radiation-curable reactive functional group flowable at 18° C. to 100° C., preferably at 20° C. to 80° C., as component (A);
II. 1 to 70% by weight, preferably more than 5% by weight, more preferably 10 to 60% by weight and most preferably 30 to 40% by weight of at least one compound containing at least one radiation-curable reactive functional group and at least one COOH group as component (B);
III. 5 to 50% by weight, preferably 20 to 45% by weight and more particularly 30 to 40% by weight of at least one nanoscale filler preferably selected from the group consisting of oxides, nitrides, halides, sulfides, carbides, tellurides, selenides of the second to fourth main group, the transition elements, the lanthanides and/or from the group of polyorganosiloxanes as component (C);
IV. 0 to 50% by weight, preferably 0.3 to 40% by weight and more particularly 0.5 to 30% by weight of at least one organosilicon compound as component (D),
V. 0 to 12% by weight, preferably 0.5 to 10% by weight and more particularly 1 to 5% by weight of a metal compound corresponding to formula (IV)
   MRₓ⁹ (V)
   in which
   M=Ge, Sn, Pb, Ti, Zr, B, Al,
   x=3 or 4
   R⁹=halogen, hydroxyl, alkoxy, alkoxycarboxyl group (R may the same or different), as component (E)
VI. 0 to 15% by weight, preferably 0 to 15% by weight and more particularly 1 to 5% by weight of a photoinitiator as component (F),
VII. 0 to 50% by weight of additives selected from the group consisting of plasticizers, catalysts, stabilizers, dispersants, antioxidants, dyes, fillers and agents for influencing the fluidity of the dispersion of component (C) in component (A), (B) or (D) or in a mixture of these components, as component (G),
   the sum total of the above-mentioned components being 100% by weight.

In a particularly preferred embodiment of the invention, the binder with barrier properties contains

10 to 50% by weight and more particularly 15 to 40% by weight of the organosilicon compound as component (D4), component (D4) being obtainable by reaction of

(i) a low-monomer polyurethane prepolymer containing free NCO groups as polyisocyanate (a), the low-monomer polyurethane prepolymer being an addition product of at least one polyisocyanate from the group consisting of IPDI, MDI or TDI and at least one polyol with a molecular weight of 150 g/mol to 2,000 g/mol and at least
(ii) one hydroxyacrylate from the group consisting of 2-hydroxyethyl(meth)acrylate, 2-hydroxypropyl(meth)acrylate, 3-hydroxypropyl(meth)acrylate, 6-hydroxyhexyl(meth)acrylate and at least
(iii) one compound corresponding to formula (II):
   Y-A-Si((Z)ₙ)(T)₃₋ₙ (II)
   in which
   Y=epoxide, —OH, —COOH, —SH, —NH₂, NHR″ group;
   R″=linear or branched, saturated or unsaturated C₁₋₁₈ alkyl, C₅₋₈ cycloalkyl, C₆₋₁₀ aryl, C₇₋₁₂ aralkyl group; oxyalkylene group containing up to 4 carbon atoms, preferably —(CH₂—CH₂—O)ₘ—H and/or (CH₂—CH(CH₃)—O—)ₘ—H; A-Si((Z)ₙ(T)₃₋ₙ; an alkyl-, cycloalkyl- or aryl-substituted siloxane group containing about 1 to about 20 Si atoms;
   A=linear or branched, saturated or unsaturated alkylene group containing 1 to 12 carbon atoms, preferably a linear or branched alkylene group containing 1 to 4 carbon atoms;
   Z=C₁₋₁₈ alkyl group, preferably C₁₋₄ alkyl group;
   T=—NH₂, —NH—CO—R⁵, —OOC—R⁵, —O—N═C(R⁵)₂ or OR⁶;
   R⁵=linear or branched, saturated or unsaturated C₁₋₁₈ alkyl group, preferably a methyl, ethyl, propyl or isopropyl group;
   R⁶=R⁵, preferably a methyl, ethyl, propyl or isopropyl group; or an oxyalkylene group containing up to 4 carbon atoms, preferably —(CH₂—CH₂—O)ₘ—H and/or (CH₂—CH(CH₃)—O)ₘ—H; a C₅₋₈ cycloalkylene group; a C₆₋₁₀ aryl group or a C₇₋₁₂ aralkyl group;
   m=1 to 40, preferably 1 to 20 and more particularly 1 to 10;
   n=0, 1 or 2.

The low-monomer polyurethane prepolymer used in step (i) contains less than 0.5% by weight, preferably less than 0.3% by weight and more particularly less than 0.1% by weight of free monomeric polyisocyanate from the group consisting of IPDI, MDI or TDI, based on the total quantity of PU prepolymer. The isocyanate groups present are intended to react off during the reaction of the constituents i, ii, iii to form D4.

In another preferred embodiment of the invention, components (D1), (D2) and/or (D3) are present in quantities of 0.3% by weight to 20% by weight, preferably in quantities of 0.4% by weight to 15% by weight and, in a particularly preferred embodiment, in quantities of 0.5 to 10% by weight, based on the overall composition of components (I) to (VII).

The radiation-curable binder with barrier properties according to the invention may also contain up to 60% by weight of an inert solvent, depending on its intended field of application.

Basically, suitable solvents are any of the solvents known to the expert, more particularly esters, ketones, halogenated hydrocarbons, alkanes, alkenes and aromatic hydrocarbons. Examples of such solvents are methylene chloride, trichloroethylene, toluene, xylene, butyl acetate, amyl acetate, isobutyl acetate, methyl isobutyl ketone, methoxybutyl acetate, cyclohexane, cyclohexanone, dichlorobenzene, diethyl ketone, diisobutyl ketone, dioxane, ethyl acetate, ethylene glycol monobutyl ether acetate, ethylene glycol monoethyl acetate, 2-ethyl hexyl acetate, glycol diacetate, heptane, hexane, isobutyl acetate, isooctane, isopropyl acetate, methyl ethyl ketone, tetrahydrofuran or tetrachloroethylene or mixtures of two or more of the solvents mentioned.

The radiation-curable binder with barrier properties according to the invention may be produced by any of the usual techniques known to the expert for the production of polymeric mixtures.

The curing of the binder leads to non-blocking, i.e., non-tacky, and above all scratch-resistant coatings, fillers or sealants with flexible properties or even surface-tacky adhesives. Accordingly, the radiation-curable binders with barrier properties according to the invention may be used as coating compositions, fillers, sealants or adhesives and are distinguished as adhesives, sealants or fillers with barrier properties against CO₂, O₂, N₂, gas mixtures, for example of CO₂ and N₂, water vapor and flavors.

Basically, the radiation-curable binder with barrier properties according to the invention is suitable for filling, sealing, coating and bonding various materials. These materials include, for example, wood, metal, glass, plant fibers, stone, paper, cellulose hydrate, plastics, such as polystyrene, polyethylene, polypropylene, polyethylene terephthalate, polyvinyl chloride, copolymers of vinyl chloride and vinylidene chloride, copolymers of vinyl acetate olefins, polyamides, or metal foils, for example of aluminium, lead or copper.

The radiation-curable binder according to the invention may be applied to the substrate by any suitable process, for example by spraying, knife coating, three/four roller application units where a solventless binder is used or two-roller application units where a solvent-containing binder is used.

The radiation-curable binder with barrier properties according to the invention is particularly suitable for coating substrates of glass, metal, plastic, paper, ceramics, etc. by dip coating, casting, spread coating, spraying, electrostatic spraying, electrocoating, etc. The binders are particularly suitable for the coating of optical, optoelectrical or electronic articles and for coating containers for motor and heating fuels.

The radiation-curable binder according to the invention represents an adhesive with barrier properties which is eminently suitable for the production of film laminates. By virtue of its content of less than 0.05% by weight of monomeric polyisocyanate, the binder is particularly suitable for the production of flexible film laminates used in the packaging of foods.

Accordingly, the present invention also relates to a process for the production of film laminates obtainable by the part- or whole-surface bonding of at least two identical or different plastic films using the radiation-curable binder with barrier properties according to the invention.

The binder may be applied to the films to be bonded using the machines typically used for such purposes, for example conventional laminating machines. It is particularly suitable to apply the binder in the liquid state to a film to be bonded to form a laminate, for example to a film of plastic or metal. The viscosity of the binder is selected so that the adhesive has a viscosity at typical application temperatures of about 500 mPas, more particularly 1,000 mPas to about 5,000 mPas (as measured with a Brookfield RVT DV-II digital viscometer, spindle 27). Typical application temperatures are, for example, about 25 to about 75° C. in the production of flexible packaging films, about 70 to about 90° C. in the lamination of high-gloss films and about 80 to about 130° C. for applications in the field of textiles.

The film thus coated with the solvent-containing radiation-curable binder with barrier properties according to the invention is first thermally pre-crosslinked (condensed) in a drying tunnel at 40 to 120° C., then laminated, optionally under pressure, with at least one other film and subsequently irradiated. For solventless binders according to the invention, the drying step is redundant.

The radiation-curable binder with barrier properties according to the invention increases in molecular weight as a result of the exposure to radiation and the resulting crosslinking reaction, thus possesses more cohesion and has the surface of a pressure-sensitive adhesive. If UV light is used as the radiation source, the binder used in accordance with the invention contains at least one photoinitiator as component (F).

The described process may be repeated several times, so that film laminates consisting of more than two bonded layers can be produced.

The process according to the invention may be carried out in an inert gas atmosphere, i.e. in the presence of inert gases, such as nitrogen. However, it may also readily be carried out with advantage in a normal atmosphere such as typically prevails in the production shops.

The present invention also relates to a laminated film produced by the process according to the invention using the binder according to the invention. The laminated film is particularly suitable as a barrier film for packaging foods. In the packaging of foods, barrier films are so called when their permeability to oxygen Q (O₂) is below 100 cm³/(m²×day×bar) and their permeability to water vapor Q (H₂O) is below 10 g/(m²×day) at 23°/85% relative humidity (Delventhal, Verpackungs-Rundschau March 1991, pages 19-23).

### EXAMPLES

Lamination Adhesive

18.75 g (component A) of a difunctional aromatic polyurethane acrylate with a molecular weight of ca. 5,000 g/mol (Akzo Nobel ACTILANE 170),
76.5 g (component B) of a carboxylic-acid-modified acrylate derivative (Cognis PHOTOMER 4173),
51.0 g finely disperse SiO₂
   are mixed and homogenized.
1.5 g (component D) allyl trimethoxysilane
   are then added and mixed.
2.25 g of a commercially available photoinitiator (Ciba IRGACURE 819) are added and homogenized. A liquid lamination adhesive is obtained.
   Comparison Test

A similar adhesive mixture is prepared without SiO₂, component C being replaced by the same quantity of component B.

Lamination Tests

The adhesive is applied to an O₂ film at ca. 80° C. in a quantity by weight of 2 g/m². A second film is then applied. The following films were laminated:
a) 2 films of oriented polypropylene (OPP) (ExxonMobil MB 400)
b) polyester film (PET) (Mitsubishi RNK) with polyethylene film (Nordenia PE K 088)

The laminate was then exposed to UV radiation from a 120 W mercury lamp (UV dose≅70 mJ/cm²). A clear, stable bond is established. The barrier behavior against water vapor is good.

Oxygen Permeability Measurements:

Tests to DIN 53380, result expressed as the average of 3 measurements.

bonded with test adhesive:

OPP//OPP laminate: 157 cm³/(m³×24 h×atm)

PET//PE laminate: 17 cm³/(m³×24 h×atm)

bonded with comparison adhesive

OPP//OPP laminate: 596 cm³/(m³×24 h×atm)

PET//PE laminate: 77 cm³/(m³×24 h×atm)

Permeability to oxygen is improved with the adhesive according to the invention.

What is claimed is:

1. A flexible film laminate comprised of at least two identical or different plastic films and a binder with barrier properties comprising:
A) at least one compound containing at least one radiation-curable reactive functional group which is flowable at 18° C. to 100° C. as component (A);
B) at least one compound containing at least one radiation-curable reactive functional group and at least one COOH group as component (B); and
C) at least one nanoscale filler as component (C).

2. A flexible film laminate as claimed in claim 1, wherein said binder has a Brookfield viscosity at 60° C. of 50 mPa·s to 52,000 mPa·s (as measured with a Brookfield RVT DV-II digital viscometer, spindle 27).

3. A flexible film laminate as claimed in claim 1, wherein component (A) comprises at least one compound selected from the group consisting of alkyl, cycloalkyl and aryl esters of poly(meth)acrylic acid, (meth)acrylic acid homopolymers, (meth)acrylic acid copolymers, unsaturated polyesters, polyethers, polycarbonates, polyacetals, polyurethanes, polyolefins, vinyl polymers and rubber polymers.

4. A flexible film laminate as claimed in claim 1, wherein component (A) comprises at least one compound selected from the group consisting of (meth)acrylic acid homopolymers, (meth)acrylic acid copolymers, polyester (meth)acrylates, epoxy(meth)acrylates and polyurethane (meth)acrylates.

5. A flexible film laminate as claimed in claim 1, wherein component (A) comprises at least one compound selected from the group consisting of esters of (meth)acrylic acid with aromatic polyols, aliphatic polyols, cycloaliphatic polyols or polyether alcohols.

6. A flexible film laminate as claimed in claim 1, wherein component (A) comprises at least one compound corresponding to general formula (I):
H₂C═CR¹—C(═O)—O—(R⁷—O)ₙR⁸ (I)
where
R¹=H, CH₃;
R⁷=linear or branched C₂-C₁₀ alkylene group;
R⁸=linear or branched C₁-C₂₅ alkyl group; and
n=1 to 25.

7. A flexible film laminate as claimed in claim 1, wherein component (A) comprises at least one compound selected from the group consisting of methoxyethyl acrylate, ethoxymethyl methacrylate, methoxyethoxyethyl methacrylate, ethoxyethoxyethyl acrylate, butyl diethylene glycol methacrylate, ethoxylated nonylphenol acrylate, ethoxylated lauryl alcohol methacrylate, alkoxylated tetrahydrofurfuryl acrylate and methoxy polyethylene glycol monoacrylate.

8. A flexible film laminate as claimed in claim 1, wherein component (A) comprises at least one compound selected from the group consisting of hydroxyfunctional ethylhexyl methacrylate, octyl acrylate, decyl acrylate, ethoxylated trimethylolpropane triacrylate, modified aromatic and aliphatic epoxyacrylates, neopentyl glycol di(meth)acrylate, 1,6-hexanediol di(meth)acrylate, trimethylolpropane tri(meth)acrylate, pentaerythritol tetra(meth)acrylate, neopentylglycol hydroxypivalate di(meth)acrylate, caprolactone-modified neopentylglycol hydroxypivalate di(meth)acrylates, ethylene-oxide-modified neopentylglycol di(meth)acrylates, propylene-oxide-modified neopentylglycol di(meth)acrylates, ethylene-oxide-modified 1,6-hexanediol di(meth)acrylates, propylene-oxide-modified 1,6-hexanediol di(meth)acrylates, polyethylene glycol di(meth)acrylates, polypropylene glycol di(meth)acrylates, pentaerythritol tri(meth)acrylate, dipentaerythritol tetra(meth)acrylate, dipentaerythritol penta(meth)acrylate, dipentaerythritol hexa(meth)acrylate, caprolactone-modified dipentaerythritol hexa(meth)acrylate, pentaerythritol tetra(meth)acrylate, tris[(meth)acryloxyethyl]-isocyanurate, caprolactone-modified tris[(meth)acryloxyethyl]-isocyanurate, caprolactone-modified trimethylolpropane tetra(meth)acrylate, dipropylene glycol diacrylate, tripropylene glycol diacrylate, tetrapropylene glycol diacrylate, neopentyl glycol propoxylate di(meth)acrylate, trimethylolpropane tri(meth)acrylate, trimethylolpropane monoethoxy tri(meth)acrylate, and amine-modified polyether acrylates.

9. A flexible film laminate as claimed in claim 1, wherein component (B) comprises at least one compound selected from the group consisting of polyether-polyol-based acid-modified (meth)acrylates, acylated carboxylic-acid-terminated polyesters, and acid-modified polybutadienes.

10. A flexible film laminate as claimed in claim 1, wherein component (C) comprises amorphous silicon dioxide.

11. A flexible film laminate as claimed in claim 1, wherein said binder additionally comprises at least one organo-silicon compound as component (D).

12. A flexible film laminate as claimed in claim 1, wherein said binder additionally comprises at least one three-dimensionally crosslinkable polyorganosiloxane which has a mean particle diameter after crosslinking of 70 nm to 1,000 nm as component (D).

13. A flexible film laminate as claimed in claim 1, wherein said binder additionally comprises at least one reaction product of acrylic acid and/or methacrylic acid or derivatives thereof with a silane (e) corresponding to general formula (II):
Y-A-Si((Z)ₙ(T)₃₋ₙ (II)
in which
Y=epoxide, —OH, —COOH, —SH, —NH₂, or NHR″ group;
R″=linear or branched, saturated or unsaturated C₁₋₈ alkyl, C₅₋₈ cycloalkyl, C₆₋₁₀ aryl, C₇₋₁₂ aralkyl group; oxyalkylene group containing up to 4 carbon atoms; A-Si((Z)ₙ(T)₃₋ₙ; or an alkyl-, cycloalkyl- or aryl-substituted siloxane group containing about 1 to about 20 Si atoms;
A=linear or branched, saturated or unsaturated alkylene group containing 1 to 12 carbon atoms;
Z=C₁₋₁₈ alkyl group;
T=—NH₂, —NH—CO—R⁵, —OOC—R⁵, —O—N═C(R⁵)₂ or OR⁶;
R⁵=linear or branched, saturated or unsaturated C₁₋₁₈ alkyl group;
R⁶=R⁵; an oxyalkylene group containing up to 4 carbon atoms; a C₅₋₈ cycloalkylene group; a C₆₋₁₀ aryl group; or a C₇₋₁₂ aralkyl group;
m=1 to 40; and
n=0, 1 or 2.

14. A flexible film laminate as claimed in claim 13, wherein the silane (e) corresponding to general formula (II) is selected from the group consisting of 3-aminopropyl trimethoxysilane, 3-aminopropyl dimethoxysilane, 3-aminopropyl triethoxysilane, 3-aminopropyl dimethoxyphenylsilane, 3-aminopropyl diethoxysilane, 3-aminopropyl trimethoxysilane, bis-(3-triethoxysilylpropyl)-amine, and mixtures thereof.

15. A flexible film laminate as claimed in claim 13, wherein said reaction product is selected from the group consisting of 3-methacryloxypropyl trimethoxysilane, allyl triethoxysilane, allyl trimethoxysilane and mixtures thereof.

16. A flexible film laminate as claimed in claim 1, wherein said binder additionally comprises at least one silane containing urethane groups with an isocyanate content of <1% by weight NCO.

17. A flexible film laminate as claimed in claim 1, wherein said binder additionally comprises at least one silane containing urethane groups and at least one radiation-curable reactive group.

18. A flexible film laminate as claimed in claim 1, wherein said binder comprises:
I. 5 to 80% by weight of at least one compound containing at least one radiation-curable reactive functional group flowable at 18° C. to 100° C. as component (A);
II. 1 to 70% by weight of at least one compound containing at least one radiation-curable reactive functional group and at least one COOH group as component (B);
III. 5 to 50% by weight of at least one nanoscale filler as component (C);
IV. 0 to 50% by weight of at least organosilicon compound as component (D);
V. 0 to 12% by weight of at least one metal compound corresponding to formula (IV)
MRₓ⁹ (IV)
in which
M=Ge, Sn, Pb, Ti, Zr, B, or Al;
x=3 or 4;
R⁹=halogen, hydroxyl, alkoxy, or alkoxycarboxyl group, wherein the R⁹ groups may be the same or different, as component (E);
VI. 0 to 15% by weight of at least one photoinitiator as component (F);
VII. 0 to 50% by weight of one or more additives selected from the group consisting of plasticizers, catalysts, stabilizers, dispersants, antioxidants, dyes, fillers and agents for influencing the fluidity of the dispersion of component (C) in component (A), (B) or (D), as component (G);
the sum total of the above-mentioned components being 100% by weight.

19. A flexible film laminate as claimed in claim 18, wherein said binder comprises 10 to 50% by weight of at least one organosilicon compound obtained by reaction of
(i) a low-monomer polyurethane prepolymer containing free NCO groups as polyisocyanate (a), the low-monomer polyurethane prepolymer being an addition product of at least one polyisocyanate selected from the group consisting of IPDI, MDI and TDI and at least one polyol with a molecular weight of 150 g/mol to 2,000 g/mol;
(ii) at least one hydroxyacrylate selected from the group consisting of 2-hydroxyethyl(meth)acrylate, 2-hydroxypropyl(meth)acrylate, 3-hydroxypropyl(meth)acrylate, and 6-hydroxyhexyl(meth)acrylate; and
(iii) at least one compound corresponding to formula (II):
Y-A-Si((Z)ₙ)(T)₃₋ₙ (II)
in which
Y=an NCO-reactive group;
A=linear or branched, saturated or unsaturated alkylene group containing 1 to 12 carbon atoms;
Z=C₁₋₁₈ alkyl group;
T=—NH₂, —NH—CO—R⁵, —OOC—R⁵, —O—N═C(R⁵)₂ or OR⁶;
R⁵=linear or branched, saturated or unsaturated C₁₋₁₈ alkyl group;
R⁶=R⁵; an oxyalkylene group containing up to 4 carbon atoms; a C₅₋₈ cycloalkylene group; a C₆₋₁₀ aryl group; or a C₇₋₁₂ aralkyl group;
m=1 to 40; and
n=0, 1 or 2.

20. A flexible film laminate as claimed in claim 19, wherein the low monomer polyurethane prepolymer contains less than 0.5% by weight of a free polyisocyanate selected from IPDI, MDI or TDI, based on the total quantity of polyurethane prepolymer.

21. A flexible film laminate as claimed in claim 1, wherein said at least one nanoscale filler is selected from the group consisting of a) oxides, nitrides, halides, sulfides, carbides, tellurides, selenides of the second to fourth main group, the transition elements, and the lanthanides and b) polyorganosiloxanes.

22. A flexible film laminate as claimed in claim 1, wherein said at least one nanoscale filler is selected from the group consisting of oxides, hydroxides, nitrides, halides, carbides and mixed oxide/hydroxide/halite compounds of aluminum, silicon, zirconium, titanium, tin, zinc, iron, alkali metals, and alkaline earth metals.

23. A flexible film laminate as claimed in claim 1, said at least one nanoscale filler having a mean particle size between 8 and 30 nm.

24. A flexible film laminate as claimed in claim 1, wherein said binder has been cured.

25. A flexible film laminate as claimed in claim 1, wherein said binder has been cured by irradiation.

26. A process for producing a flexible film laminate in accordance with claim 1, said process comprising using said binder to bond together said at least two plastic films.

27. A process for producing a flexible film laminate in accordance with claim 1, said process comprising coating a first plastic film with said binder, optionally thermally pre-crosslinking said binder, laminating said first plastic film to a second plastic film, and irradiating said binder.

28. A food packaged in the flexible film laminate of claim 1, wherein the binder is cured.

29. A method of packaging a food, said method comprising using the flexible film laminate of claim 1.

30. A binder with barrier properties comprising:
i. 5 to 45% by weight of at least one compound containing at least one radiation-curable reactive functional group flowable at 20° C. to 80° C. and selected from the group consisting of (meth)acrylic acid homopolymers, (meth)acrylic acid copolymers, polyester(meth)acrylates, epoxy(meth)acrylates and polyurethane(meth)acrylates as component (A);
ii. 10 to 60% by weight of at least one compound containing at least one radiation-curable reactive functional group and at least one COOH group selected from the group consisting of polyether-polyol-based acid-modified (meth)acrylates, acylated carboxylic-acid-terminated polyesters, and acid-modified polybutadienes as component (B);
iii. 30 to 40% by weight of amorphous silicon dioxide having a mean particle size between 10 and 25 nm as component (C);
iv. 0.3 to 40% by weight of at least one organosilicon compound selected from the group consisting of 3-aminopropyl trimethoxysilane, 3-aminopropyl dimethoxysilane, 3-aminopropyl triethoxysilane, 3-aminopropyl dimethoxyphenyl silane and 3-aminopropyl diethoxysilane, 3-aminopropyl trimethoxysilane, and bis-(3-triethoxysilylpropyl)-amine as component (D);
v. 0 to 12% by weight of at least one metal compound corresponding to formula (V)
MRₓ⁹ (V)
in which
M=Ge, Sn, Pb, Ti, Zr, B, or Al;
x=3 or 4;
R⁹=halogen, hydroxyl, alkoxy, or alkoxycarboxyl group, wherein the R⁹ groups may the same or different, as component (E);
vi. 0.1 to 5% by weight of at least one photoinitiator as component (F);
vii. 0 to 50% by weight of one or more additives selected from the group consisting of plasticizers, catalysts, stabilizers, dispersants, antioxidants, dyes, fillers and agents for influencing the fluidity of the dispersion of component (C) in component (A), (B) or (D), as component (G);
the sum total of the above-mentioned components being 100% by weight.
